(19) United States
(12) Patent Application Publication
(10) Pub. No.: US 2007/0033215 A1
(43) Pub. Date: Feb. 8, 2007

(54) System and method for providing certificate based on animal health and history data

(76) Inventors: James F. Heinle, Cranford, NJ (US); Daniel Ellsworth, Stewartsville, NJ (US); Tyler R. Brown, Smithville, MO (US); Richard L. Sibbel, Ankeny, IA (US)

Correspondence Address: PATENT DOCKET ANDMINSTRATOR;LOWENSTEIN SANDLER PC, 65 LIVINGSTON AVENUE, ROSELAND, NJ, 07068, US

(21) Appl. No.: 11/198,880

(22) Filed: Aug. 5, 2005

(51) Int. Cl. G06Q 10/00; A01K 29/00

(52) U.S. Cl. 707/102; 434/154; 705/28; 119/174

(57) ABSTRACT

A certificate for animal data is provided in a network environment. Initially, animal data is stored in a database. The stored animal data is then displayed for verification. The displayed data is verified by a user independent of animal ownership. Finally, a certificate that comprises the verified animal data and a signature field is issued such that, if signed, the certificate provides assurance of the verification of the animal data.

### BACKGROUND OF THE INVENTION

The present invention relates to a system and method for managing animal data. More particularly, the present invention relates to a system and method for storing and managing livestock health and history data, and providing animal certificates on the basis of such data, which is accessed via local area network or wide area network by various registered users.

The cattle industry, being a representative example of the livestock industry, comprises several vertically integrated segments, such as producers, feedlot operators, packing plant operators, and wholesalers/retailers. The cattle industry cycle starts with the commercial cattle producers maintaining herds of cows for producing calves. The calves are grown to a certain size and then moved to feedlots, where they are cared for in various stages of growth. In the feedlots, the animals are fed a special diet to reach their optimum weight and size while trying to keep them healthy. Subsequently, the animals are sent to the packing plants for slaughter. Also in the packing plants the animal carcasses are cut into various portions or cuts of meat. These cuts of meat are packed, chilled and shipped by the packers to the wholesalers and/or retailers for distribution to the public.

With mad cow disease making recent headlines in the U.S. media, wholesalers, retailers and, in particular, consumers express many concerns about the safety of meat products. Relevant to the issue of safety is collection, storage and management of such cattle information as individual birth dates, health procedures, origin, etc.

A need, therefore, arises for a system and method for collecting, storing and managing animal health and history, and for providing certification of such information by an independent party.

### SUMMARY OF THE INVENTION

It is an object of the present invention to provide a system and method for storing and managing animal health and history data, and providing animal certificates on the basis of such data.

The above and other objects are achieved by such inventive system and method. According to one embodiment of the present invention, a certificate for animal data is provided in a network environment. According to this embodiment of the present invention, animal data is stored in a database. The stored animal data is then displayed for verification. The displayed data is verified by a user independent of the animal ownership. Finally, a certificate that comprises the verified animal data and a signature field is issued such that, if signed, the certificate provides assurance of the verification of the animal data.

### BRIEF DESCRIPTION OF THE DRAWINGS

The foregoing and other features of the present invention will be more readily apparent from the following detailed description and drawings of one or more illustrative embodiments of the present invention in which:

FIG. 1 is a block diagram of the system for storing and managing livestock health and history data, and providing animal certificates on the basis of such data according to one embodiment of the present invention;

FIG. 2 is a graphical representation of screen display showing an unsecured web site home page;

FIG. 3 is a graphical representation of screen display showing a login to the web site;

FIG. 4 is a graphical representation of screen display showing a home page of the secure web site;

FIG. 5 is a graphical representation of screen display when “Manage Operations” item is selected;

FIG. 6 is a graphical representation of screen display when a user desires to add operations;

FIG. 7 is a graphical representation of screen display when a user desires to add operations with fields populated;

FIG. 8 is a graphical representation of screen display after the information on a new operation has been submitted for entry into the database;

FIG. 9 is a graphical representation of screen display when a user activates “Manage Animals” action item on the web page;

FIG. 10 is a graphical representation of screen display when a user desires to manage animals in his/her operations;

FIG. 11 is a graphical representation of screen display for manually adding animals;

FIG. 12 is a graphical representation of screen display for manually adding animals with fields populated;

FIG. 13 is a graphical representation of screen display after the information on a new animal has been submitted for entry into the database;

FIG. 14 is a graphical representation of screen display when “Certificates” action item is selected;

FIG. 15 is a graphical representation of screen display at the first stage of certificate issuance;

FIG. 16 is a graphical representation of screen display when “Select this operation” in the certificate issuance procedure is selected;

FIG. 17 is a graphical representation of screen display at a second stage of certificate issuance;

FIG. 18 is a graphical representation of screen display at a third stage of certificate issuance;

FIG. 19 is a graphical representation of screen display at a fourth stage of certificate issuance;

FIG. 20 is a graphical representation of screen display of the certificate in final form;

FIG. 21 is a process flowchart for storing and managing livestock health and history data, and providing animal certificates on the basis of such data.

### DETAILED DESCRIPTION OF PREFERRED EMBODIMENTS

The present invention applies to livestock industry in general, and one representative example of the present invention described herein is directed to cattle industry.

As a general overview, the present invention includes a system, method and storage medium for storing and managing livestock health and history data, and providing animal certificates on the basis of such data, which is accessed via local area network or wide area network by various registered users. In accordance with one embodiment of the present invention, a cattle producer or a veterinarian accesses a secure database via his/her personal computer to enter, review or modify information about an animal or a group of animals. This information may include the name and location of the operation (cattle farm, for example), animal's date of birth, animal's various identification numbers, animal's health history, etc. At the producer's request, the veterinarian reviews the electronic information of the animal or group of animals and then certifies that the information is correct via an electronic signature, for example. An electronic signature, including the first and last names of the veterinarian, may be implemented via various input devices, such as a stylus with a pressure-sensitive tablet or screen, as known to those skilled in the art. An electronic certificate is then issued for that particular animal or group of animals, such that the owner of the operation may e-mail or alternatively provide a hard copy of the certificate to a potential buyer for source, origin and/or health history verification purposes.

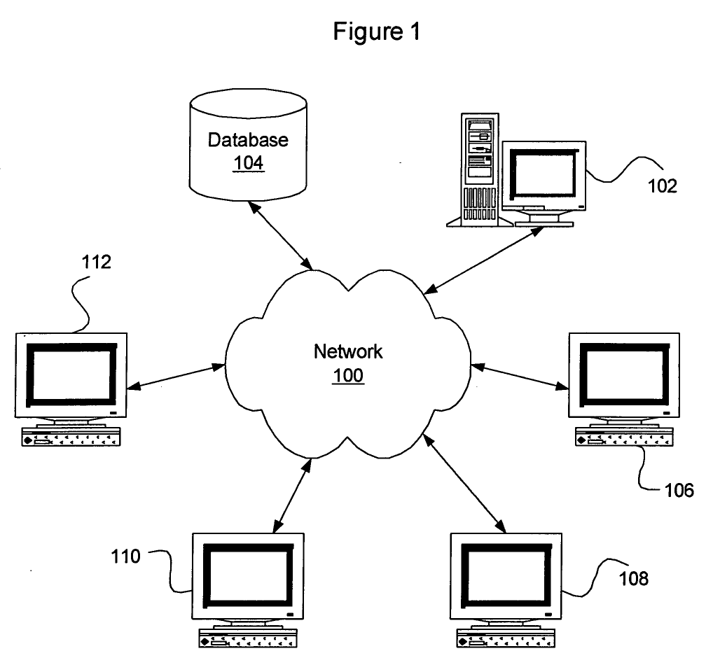

FIG. 1 is a block diagram of the system for storing and managing livestock health and history data, and providing animal certificates on the basis of such data according to one embodiment of the present invention. Shown in the figure in block diagram form are personal computers (PC) 104, 106, 108 and 110. In one embodiment of the present invention, PC 104, PC 106, PC 108 or PC 110 may be a general purpose computer containing a display screen for displaying images, text, etc., a memory storage medium for storing data, an input device for providing user access to the system by entering user input data, a programmable processor for controlling operations of the various PC components, and a network interface device, such as a modem, for connecting the personal computer to a network, thereby providing communication with other personal computers and computer servers. A dial-up modem, DSL modem, cable modem, network card and/or any other interface device, alone or in combination, may be used for accessing other personal computers and computer servers via any wired or wireless communications medium. Additionally, PC 104, PC 106, PC 108 and PC 110 may include speakers and/or microphone (not shown) for providing auditory and speech interface between the user and the system.

While only 4 computers—and therefore 4 users—are illustratively shown in FIG. 1, it is understood that a plurality of people may be using the system. It is further understood that each illustrated computer setup may contain other hardware and/or software components or elements that are necessary for the normal operation of a computer, as known to those skilled in the art. Since the additional hardware and/or software elements or components are not critical to the understanding of the present invention, a detailed description thereof will be omitted in order not to detract from the present invention.

When connected via a network interface device, PC 104, PC 106, PC 108 and PC 110 represent 4 respective nodes on network 100. This network may be a global computer implemented network, such as the Internet, or any other type of network, such as an Intranet, Virtual Private Network (VPN), local area network (LAN), wide area network (WAN), etc. Connected to network 100 via their respective network interface devices is a plurality of users, which may be cattle producers, feedlot operators, veterinarians or other cattle industry participants with interest in the cattle source, origin and/or health history verification, for example. In the embodiments of the present invention, they may be representatively referred to herein as users to facilitate the understanding of the present invention. These users may employ a variety of wireless/wired devices to connect to the network: desktop personal computers, portable/laptop computers, wireless/wired personal digital assistants, cellular telephones, specific Web access devices (WebTV), etc. Collectively, any one of these network users operating PC 104, PC 106, PC 108 or PC 110 is representatively referred to herein as PC 104, PC 106, PC 108 or PC 110, respectively, as shown in FIG. 1.

Also connected to network 100 is server 102 for storing program code, when executed by a programmable processor, is operative to process data, access a database and/or perform all other operations as described herein. Database 104, connected to server 102, stores data representing livestock health and history data, as well other data representing information in, connection with the embodiments of the present invention, as explained in detail below. Also stored in database 104 may be user registration data to gain access to the system. It is understood that the database may be remotely located from the server or, alternatively, may be co-located with the server. Furthermore, the database may be a distributed database, comprised of a cluster of databases.

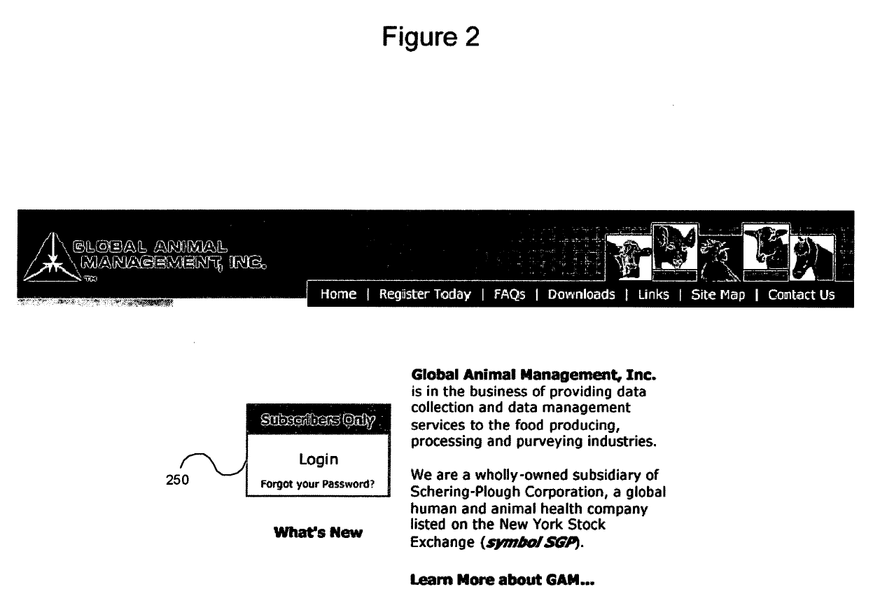

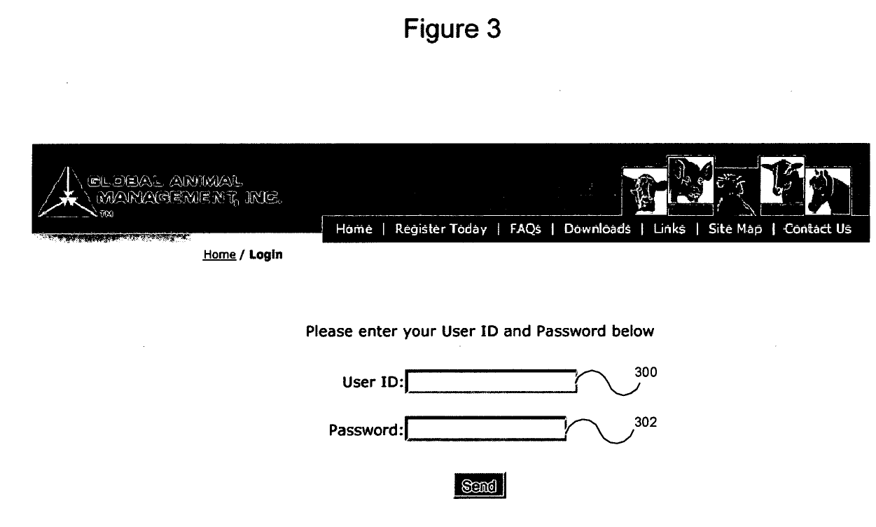

In operation, users access the system via their respective personal computers, such as PC 104, PC 106, PC 108 and PC 110. According to one embodiment of the present invention, let it be assumed that a cattle producer wants to create a certificate for an animal to be sold to another cattle producer. Using PC 108, for example, he establishes communication—via network 100—with server 102 that hosts a web site in accordance with one embodiment of the present invention. The web site is typically accessed by entering its Universal Resource Locator (URL) address in a browser program. The server responds with HTML-based documents representing the web site. It will be appreciated that any protocol, markup language, etc., may be used between clients and a server to transfer files, web pages, etc., therebetween, as known to those skilled in the art. Typically, the unsecured web site home page is displayed initially, as illustrated in FIG. 2. By pointing and clicking on box 250, which is a link to another web page, the cattle producer is presented with a login screen as shown in FIG. 3.

According to FIG. 3, a login procedure is implemented to allow only the registered users access to the web site contents. In this regard, the user is requested to enter his/her user ID in field 300 and password in field 302 for authorization and confirmation. The entered information is transferred to the server 102 and checked against the pre-stored information in the database 104. The server 102 verifies the entered information by cross-referencing it against the registered user information stored in the database 104. If the entered information is valid, the access to the system is allowed. If, however, the entered information does not correspond to the database-stored information, an error message is displayed on the screen of the user device (PC 108), and the user is invited to re-enter his/her access information. The login screen may not appear after a certain number of tries to prevent “hacking” into the system.

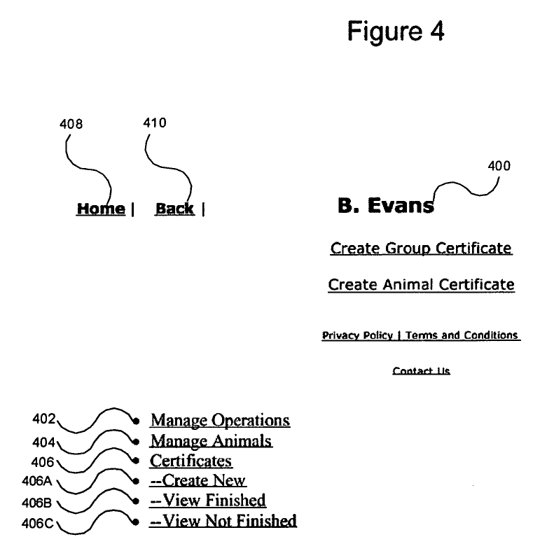

Assuming that the registered user is authenticated, the cattle producer gains access to the system. FIG. 4 is a graphical representation of screen display showing a home page of the secure web site according to one embodiment of the present invention. As shown in this figure, the name of the user, representatively shown as item 400 “B. Evans”, appears at the top of the page based on the initial user registration information. It is understood, of course, that any other identifier, such as the operation name, for example, may appear instead. Further, the home page includes a menu containing a number of action items—links to other web pages—to provide functionality to the web site. These action items are “Manage Operations” 402, “Manage Animals” 404, and “Certificates” 406. Under “Certificates”, the actions items are “—Create New” 406A, “—View Finished” 406B, and “—View Not Finished” 406C. Additionally provided on the home and other web pages on this web site are such traditional links as “Home” 408 and “Back” 410, their functions being universally understood by any user of the World Wide Web (www).

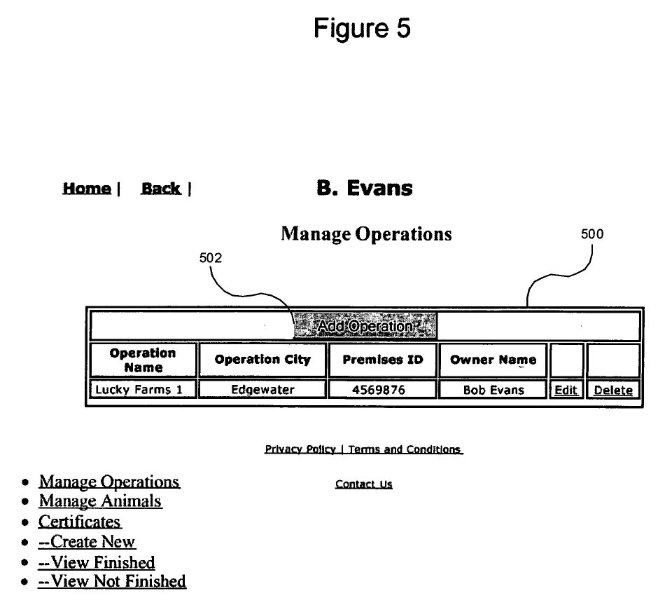

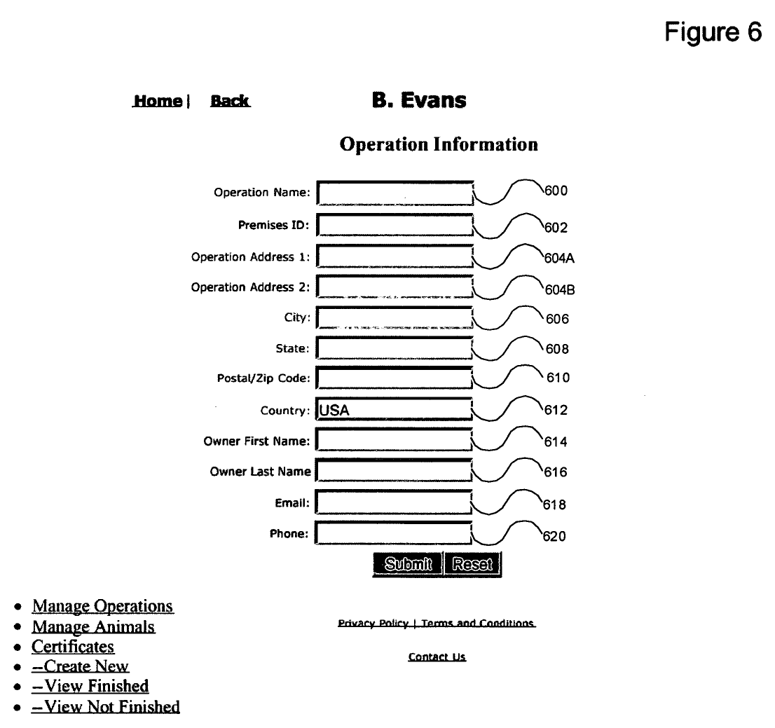

FIG. 5 is a graphical representation of screen display when “Manage Operations” item 402 is selected. As shown in this figure, the cattle producer, B. Evans, has one operation already entered into the database 104 and displayed in table 500. Let it be assumed that B. Evans has another farm to enter into the database 104. To this end, he clicks on “Add Operation” action item 502 to activate another web page as shown in FIG. 6.

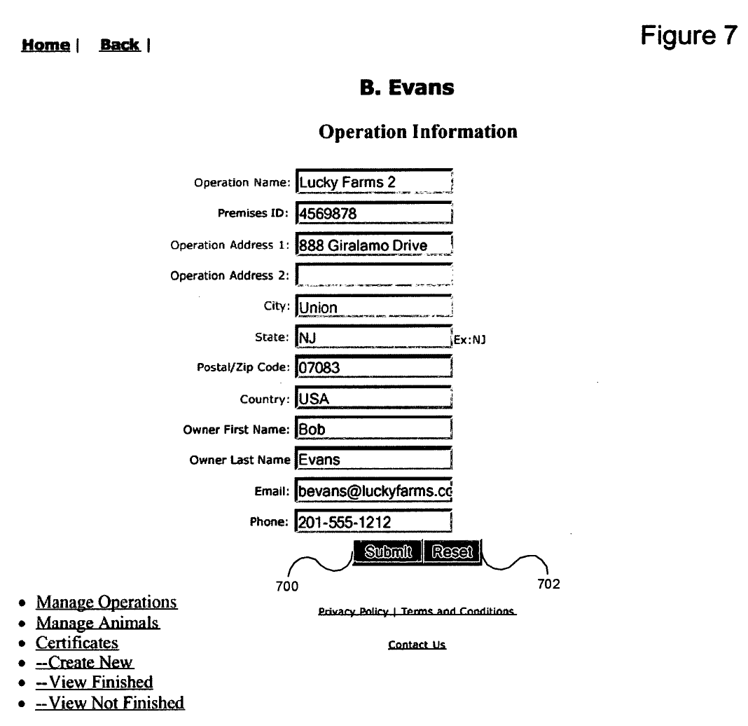

FIG. 6 is a graphical representation of screen display when a user desires to add operations in accordance with one embodiment of the present invention. As shown in this figure, the cattle producer enters information into the following fields: “Operation Name” 600; “Premises ID” 602; “Operation Address 1” 604A; “Operation Address 2” 604B; “City” 606; “State” 608; “Postal/Zip Code” 610; “Country” 612; “Owner First Name” 614; “Owner Last Name” 616; “Email” 618; and “Phone” 620. These fields may be representatively populated as shown in FIG. 7. Thereafter, “Submit” action item 700 of FIG. 7 is activated in order to transfer this information to the database. Alternatively, “Reset” action item 702 may be activated in order to cancel the information in the fields.

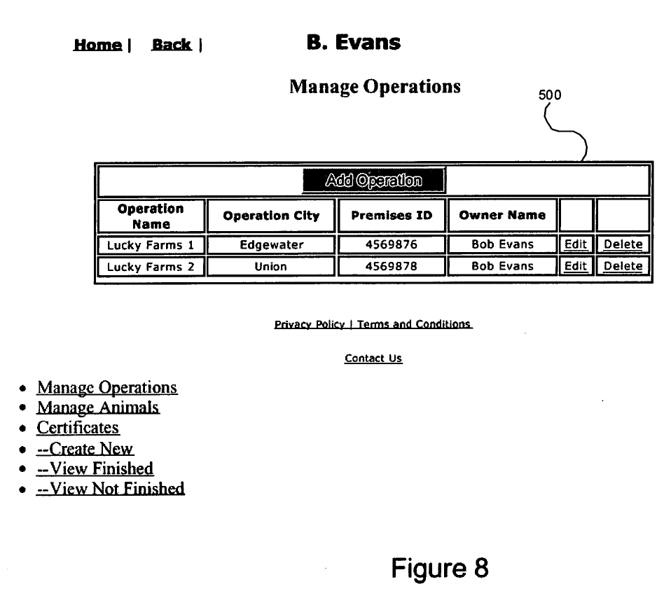

FIG. 8 is a graphical representation of screen display after the information on a new operation has been submitted for entry into the database. This figure is an illustration of the updated table 500 containing information on the B. Evan's operations.

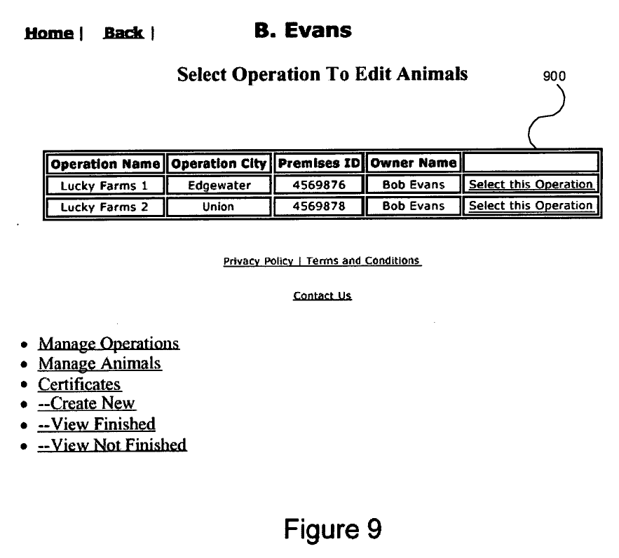

Let it be assumed now that this cattle producer desires to manage animals pertaining to those operations. He then selects “Manage Animals” action item 404 to activate a web page as shown in FIG. 9.

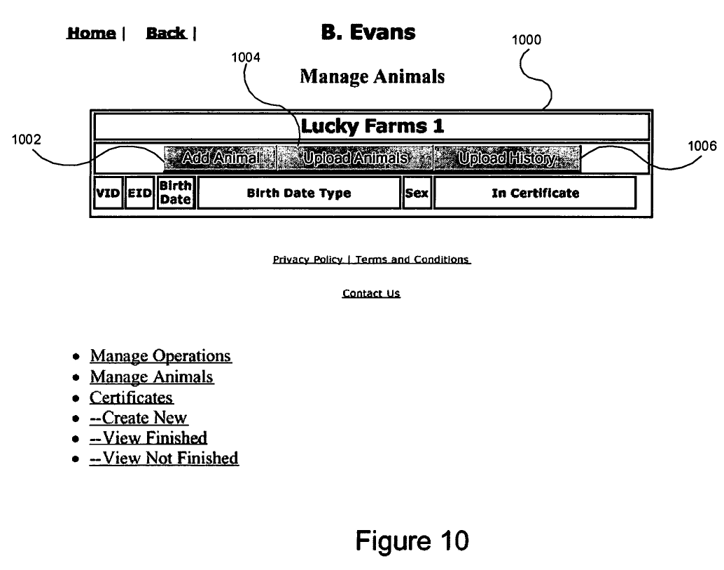

FIG. 9 is a graphical representation of screen display when a user activates “Manage Animals” action item on the web page. This figure is an illustration of Table 900 listing information about the operations with an additional field to select an operation. Let it be assumed that B. Evans selects the “Lucky Farms 1” operation to manage his animals on that farm. Based on the selection of this action item, a web page is presented on PC 108 as shown in FIG. 10.

FIG. 10 is a graphical representation of screen display when a user desires to manage animals in his/her operations. As shown in this figure, table 1000 contains a number of fields pertaining to the animals. Also contained in the table 1000 are “Add Animal” action item 1002, “Upload Animals” action item 1004, and “Upload History” action item 1006. Action item 1002 is a manual entry as will be described in detail below. Action item 1004 is an automatic entry of animal information from data files stored in such formats as Excel, Access, etc. When such file is uploaded to the server, the information is extracted and then directed to specific fields in the table 1000. When activated, action item 1006 is operative to populate fields in the similar manner.

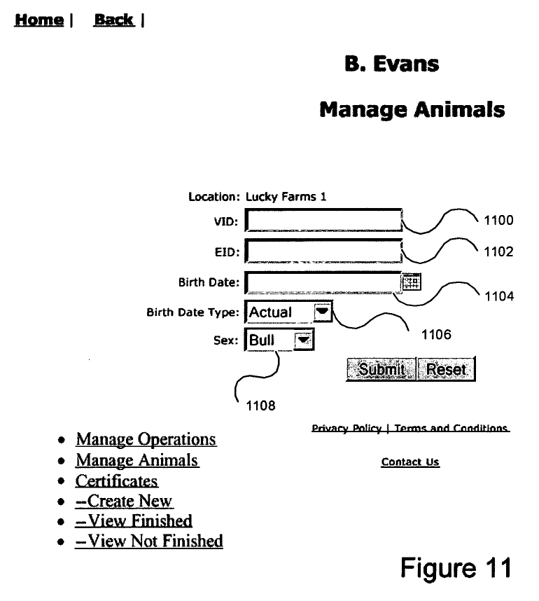

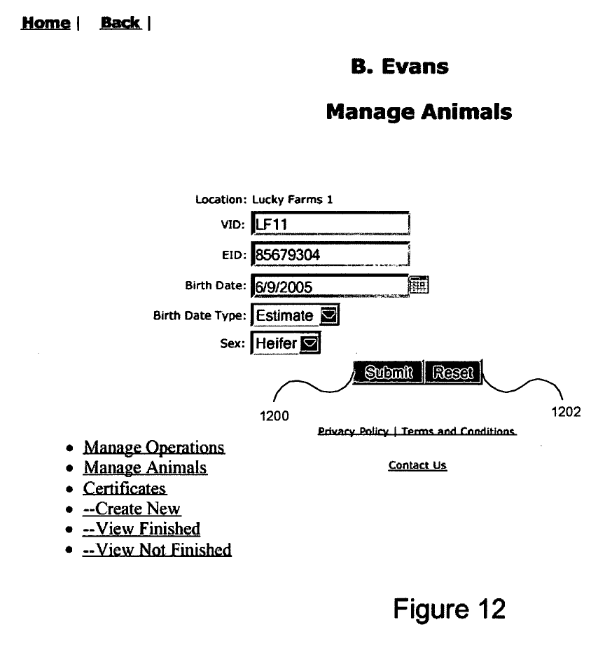

Turning to action item 1002 in more detail, a web page is transferred from the server to the client as shown in FIG. 11. FIG. 11 is a graphical representation of screen display for manually adding animals. According to this figure, the cattle producer enters information into the following fields: visual ID (“VID”) 1100; electronic ID (“EID”) 1102; “Birth Date” 1104; “Birth Date Type” 1106; “Sex” 1108. These fields may be representatively populated as shown in FIG. 12. Thereafter, “Submit” action item 1200 of FIG. 12 is activated in order to transfer this information to the database. Alternatively, “Reset” action item 1202 may be activated in order to cancel the information in the fields. It will be noted that in “Birth Date” field 1104, an on-screen calendar is provided to assist the user in entering the birth date information. In addition, “Birth Date Type” field 1106 can have the values of “actual” or “estimate” animal birth dates, while “Sex” field 1108 can have the values “Heifer”, “Bull” “Steer” or “Cow”.

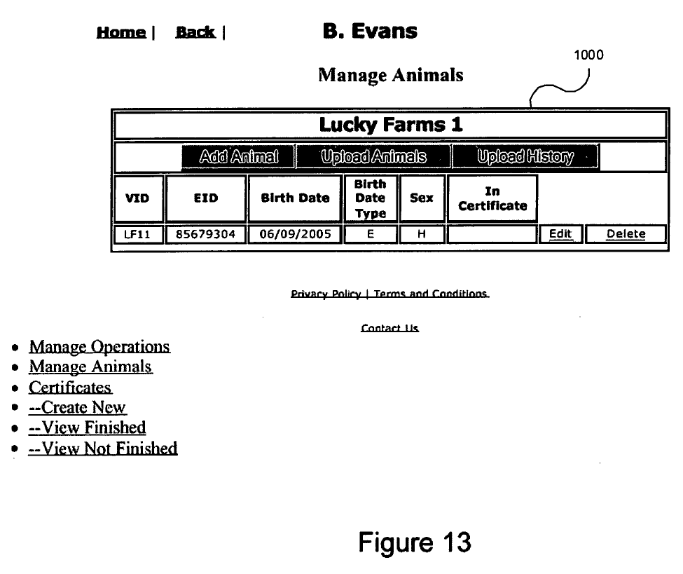

FIG. 13 is a graphical representation of screen display after the information on a new animal has been submitted for entry into the database. This figure is an illustration of the updated table 1000 containing information on the Lucky Farms 1 animals. It will be noted that “Edit” and “Delete” action items are added for each animal entered into the database.

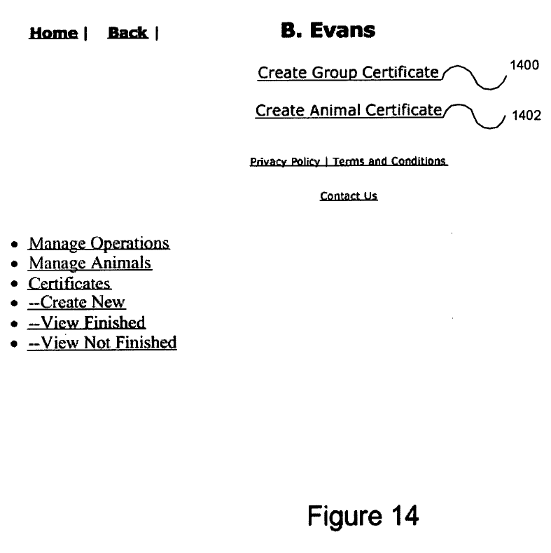

Let it be assumed now that this cattle producer desires to have a certificate issued for an animal in preparation for its sale to another cattle producer, feedlot operator, etc. To this end, B. Evans selects “Certificates” action item 406 to activate a web page as shown in FIG. 14.

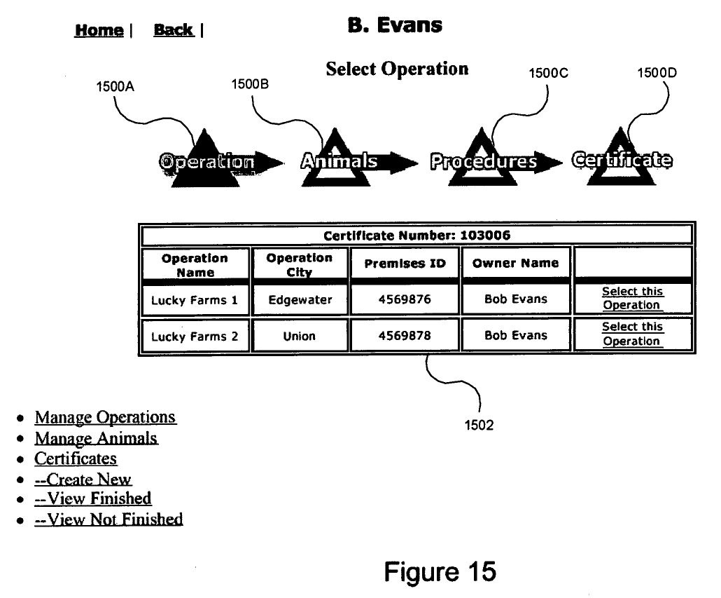

FIG. 14 is a graphical representation of screen display when “Certificates” action item 406 is selected. According to this figure, the user is presented with 2 choices: “Create Group Certificate” action item 1400 for a group of animals, and “Create Animal Certificate” action item 1402 for an individual animal. Let it be assumed that action item 1402 is selected such that a web page appears on PC 108 as shown in FIG. 15. As shown in this figure, progress triangles 1500A-1500D are displayed above table 1502 containing the stored information on B. Evan's operations.

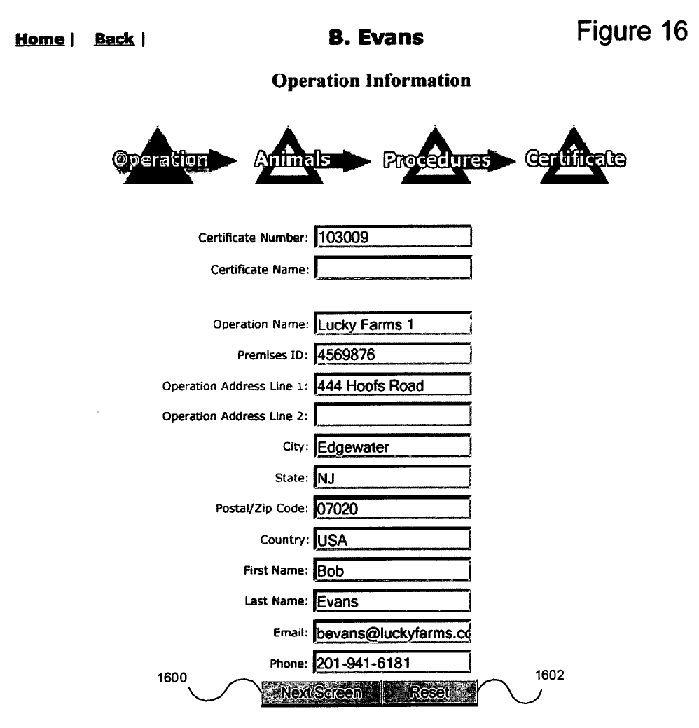

In the first stage of certificate issuance, an operation is selected from table 1502. Once the cattle producer selects a particular operation, a web page is presented as shown in FIG. 16.

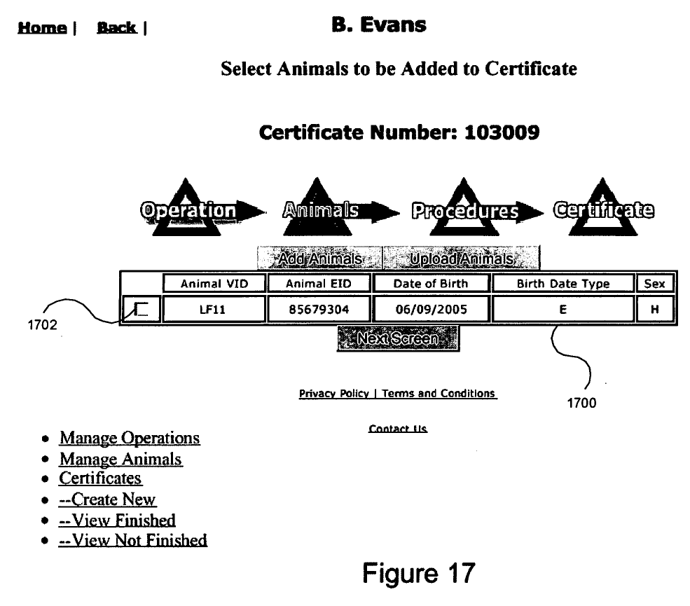

FIG. 16 is a graphical representation of screen display when “Select this operation” in the certificate issuance procedure is chosen. More specifically, the operation information with all fields, as previously populated by the user, is provided for review and confirmation. Two action items “Next Screen” 1600 and “Reset” 1602 are displayed for user activation. Assuming that the information, as previously entered into the database is correct, and “Next Screen” is activated, information on all animals entered for that particular operation is presented in a tabular form as shown in FIG. 17.

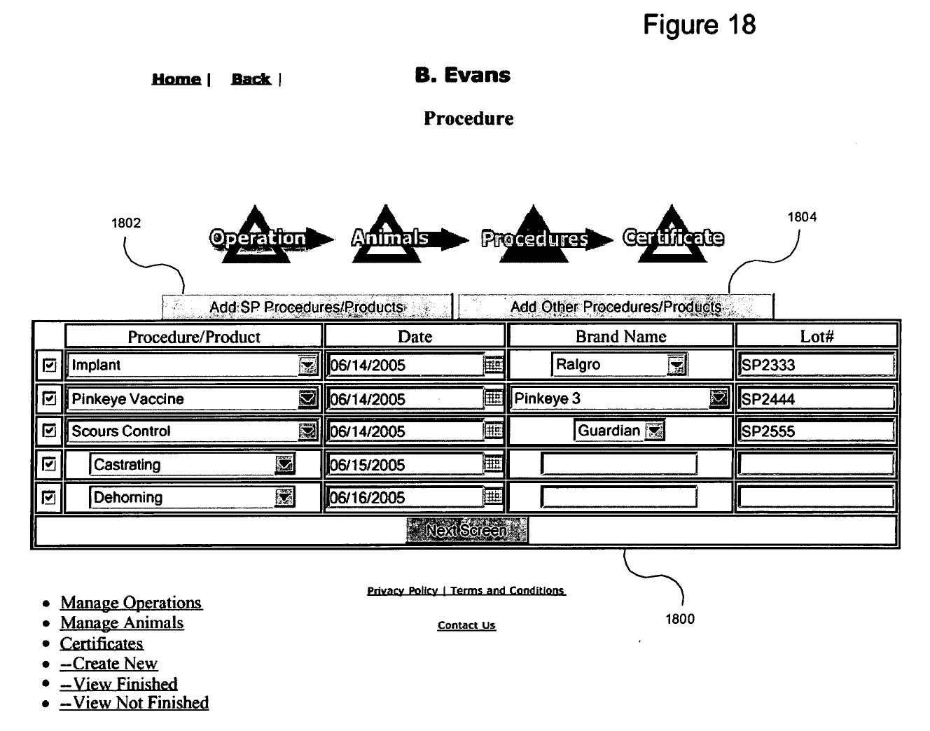

FIG. 17 is a graphical representation of screen display at a second stage of certificate issuance. According to this figure, table 1700 contains a check mark box 1702 for selecting a particular animal for which a certificate is to be issued. It will be noted that the progress triangles moved to the second stage. It is understood that many animals may be listed in the table 1700 and when a particular animal is selected (in this representative example only one animal is listed and therefore selected for illustrative purposes), the next web page is shown in FIG. 18.

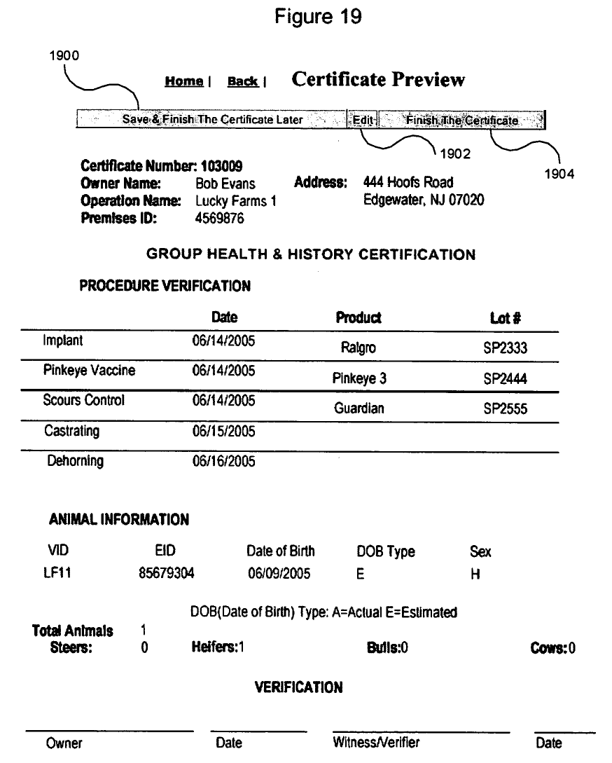

FIG. 18 is a graphical representation of screen display at a third stage of certificate issuance. At this stage, the cattle producer may enter various procedures, products and other health-related information for that animal. This information is stored in table 1800 as shown in FIG. 18. Various animal procedures and products are presented in a menu-style format with drop-down menus 1802 and 1804. After entering the health-related information, the user moves to the fourth and final stage of certificate issuance via “Next Screen” action item 1806. In response, a web page is transmitted from the server to the client as shown in FIG. 19.

FIG. 19 is a graphical representation of screen display at a fourth stage of certificate issuance. According to this figure, B. Evans may preview a certificate for the selected animal and then perform the following actions: “Save & Finish The Certificate Later” 1900; “Edit” 1902; “Finish The Certificate” 1904. The action item 1900 is used when further health-related procedures or products will be administered to the animal. The action item 1902 is to change any information if incorrect, and the action item 1904 is to issue the certificate for the selected animal. If the action item 1904 is selected, the user is presented with a warning that indicates once the certificate is issued, it cannot be modified or deleted, and all information on that animal is removed from all the tables under “Manage Operations” and “Manage Animals” items.

Furthermore, the verification section of the certificate requires execution by the owner/manager of the operation and a witness/verifier, typically a veterinarian. Preferably, electronic signatures are requested on the certificate; however, the certificate can also be printed out and signed/dated in a conventional manner.

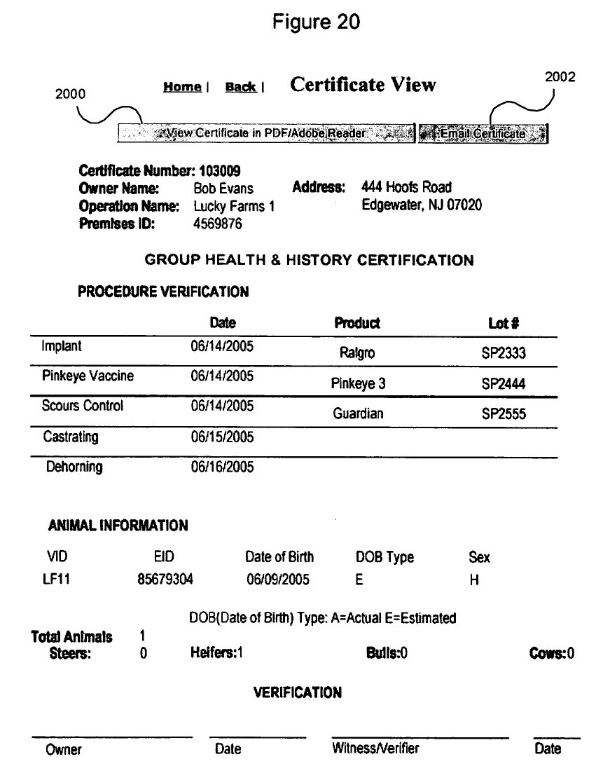

FIG. 20 is a graphical representation of screen display of the certificate in final form. As shown in this figure, the certificate holder can view it in PDF format or e-mail it to the potential buyer, in accordance with action items 2000 and 2002, respectively.

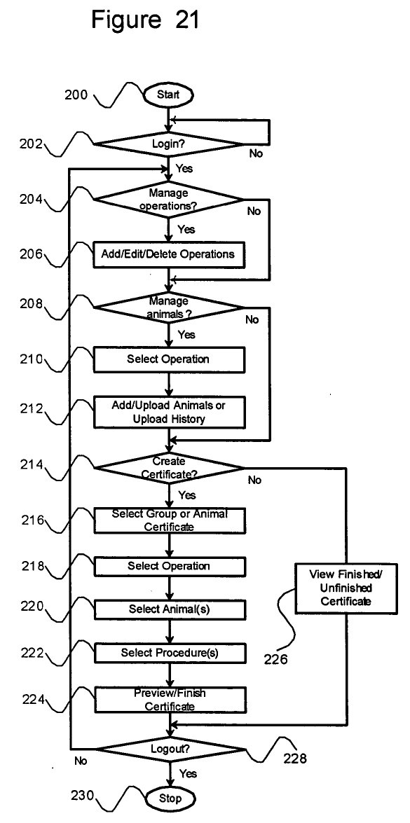

FIG. 21 is a process flowchart for storing and managing livestock health and history data, and providing animal certificates on the basis of such data in accordance with one embodiment of the present invention. After “Start” 200, a decision is made whether a login procedure is initiated shown in block 202. If successful, it is determined whether operations are to be managed in block 204. If the answer is affirmative, such functions as add, edit, delete are performed with respect to each selected operation in block 206. Another decision is then made whether animals are to be managed in block 208. If so, an operation is selected in block 210, and then animals added manually, uploaded automatically, or animal history uploaded in block 212. In block 214 it is determined whether a certificate is to be created. If so, a group certificate or animal certificate is selected in block 216. Then, an operation is selected in block 218, followed by a selection of animals in block 220. In block 222, animal procedures and/or products are selected, and a certificate is previewed or finished in block 224. Alternatively, a finished or unfinished certificate can be viewed in block 226. A decision is made in block 228 whether the user requests a logout. If so, “Stop” 230 is entered; otherwise, the process returns to block 204.

The above description of the process flowchart and FIGS. 1-20 refers to various operations, such as select, determine, enter, populate, authenticate, etc. It is understood, of course, that those and other operations are performed by one or more programmable processors/controllers in the server and in the PCs executing appropriate program code stored on a computer-readable storage medium. As known to those skilled in the art, a programmable processor/controller retrieves the code, transfers the retrieved code to its internal memory and executes it from the internal memory. In response to the executed code, the appropriate actions take place to carry out the above-described and other functions of the system.

While the above arrangement is one embodiment of the present invention, it is not limited thereto. In the present invention, dumb terminals may replace the personal computers, or alternatively personal computers may be utilized merely as dumb terminals. In this configuration, the terminals are connected via wires (without modems) to a main computer, where all processing operations take place such that the users employ the terminals only as data input devices.

Yet in another embodiment, the present invention may be implemented on a microprocessor-accessible storage medium such as computer memory, compact disk (CD), video cassette, digital video disk (DVD), Digital Audio Tape (DAT), etc. In this case, the entire program code and database information are stored on the storage medium that can be accessed by a microprocessor, programmable controller, or any other programmable device.

It will be appreciated that while in the above-described preferred embodiment a veterinarian reviews and certifies, via a signature for example, that the information in a certificate is true and accurate to the best of his or her knowledge, other people or users who are independent of animal ownership may carry out this function. They may include any person who does not have an ownership interest in either the animal(s) or animal farm/operation, and preferably, is also not an employee of the animal owner or animal farm/operation.

It will be further appreciated that while in the above-described preferred embodiment a certificate is signed via an electronic signature using the first and last names of the signer, an electronic signature comprises other forms of acknowledgment. That is, in accordance with other embodiments of the present invention an electronic signature may comprise an electronic sound, symbol, or process attached to or logically associated with a certificate and executed or adopted by a person with the intent to sign the certificate.

While the present invention has been described and illustrated in connection with the above embodiments, many variations and modifications, as will be evident to those skilled in the art, may be made without departing from the spirit and scope of the present invention. The embodiments of the present invention are thus not to be limited to the precise details of methodology or construction set forth above, as such variations and modifications are intended to be included within the scope of the present invention.

What is claimed is:

1. A method for providing a certificate for animal data in a network environment, comprising:
storing animal data in a database;
displaying the stored animal data for verification;
verifying the displayed data by a user independent of animal ownership; and
issuing a certificate that comprises the verified animal data and a signature field such that, if signed, said certificate provides assurance of the verification of said animal data.

2. The method according to claim 1, wherein said animal data pertains to an individual animal or a group of animals.

3. The method according to claim 1, further comprising entering said animal data into said database manually.

4. The method according to claim 1, further comprising transferring said animal data into said database by uploading from another application program.

5. The method according to claim 1, wherein said animal data comprises health procedures and products data.

6. The method according to claim 1, wherein said animal data comprises operation information, animal ID, sex and birth data.

7. The method according to claim 1, further comprising securing said animal data in said database via a user ID and a password.

8. The method according to claim 1, wherein said animal data is entered by an owner and said certificate is signed by a veterinarian.

9. The method according to claim 1, wherein a veterinarian enters said animal data and signs said certificate.

10. The method according to claim 1, wherein said certificate further comprises another signature field for verification by an animal owner.

11. The method according to claim 1, wherein said signature field comprises an electronic signature.

12. The method according to claim 11, further comprising e-mailing said certificate, when completed, to an interested party.

13. A system for providing a certificate for animal data in a network environment, comprising:
a storage medium for storing animal data in a database; and
a processor programmed to execute code which is operative to display the stored animal data for verification, verify the displayed data by a user independent of animal ownership, and issue a certificate that comprises the verified animal data and a signature field such that, if signed, said certificate provides assurance of the verification of said animal data.

14. The system according to claim 13, wherein said animal data pertains to an individual animal or a group of animals.

15. The system according to claim 13, wherein said animal data comprises health procedures and products data.

16. The system according to claim 13, wherein said animal data comprises operation information, animal ID, sex and birth data.

17. The system according to claim 13, wherein said signature field comprises an electronic signature.

18. The system according to claim 17, wherein said certificate is e-mailed, when completed, to an interested party.

19. A computer-readable storage medium having recorded thereon code, executable by a processor, for providing a certificate for animal data in a network environment, said code being operative to perform actions comprising:
storing animal data in a database;
displaying the stored animal data for verification;
verifying the displayed data by a user independent of animal ownership; and
issuing a certificate that comprises the verified animal data and a signature field such that, if signed, said certificate provides assurance of the verification of said animal data.
